(19) United States
(12) Patent Application Publication
(10) Pub. No.: US 2018/0083772 A1
(43) Pub. Date: Mar. 22, 2018

(54) PERPETUAL ENCRYPTION SYSTEM, METHOD, AND SOFTWARE PROGRAM PRODUCT

(71) Applicant: Daniel Patrick Mullarkey, Woodlynne, NJ (US)

(72) Inventor: Daniel Patrick Mullarkey, Woodlynne, NJ (US)

(21) Appl. No.: 15/270,861

(22) Filed: Sep. 20, 2016

(51) Int. Cl. H04L 9/06

(52) U.S. Cl. CPC H04L 9/0662

(57) ABSTRACT

A core encryption algorithm that can be used to create perpetual encryption. This encryption algorithm is based on conditional mathematical formulas instead of non-conditional mathematical formulas.

### BACKGROUND OF THE INVENTION

The present invention relates to data encryption, and more particularly to a systems, methods, and apparatus for the encryption of data in a computing environment.

Currently, encryption algorithms can be easily enough hacked into because they lack the capacity to be used for perpetual encryption.

Other encryption algorithm systems are too easily hacked or are inexact in nature and cannot be used for perpetual encryption.

Other encryption algorithm systems are usually lossless, gain less, or can be too easily decrypted if the algorithm is discovered due to the fact that they cannot be used for perpetual encryption.

By comparison, other systems usually either increase the size of the data or use lossy compression to shorten the data. That is they package the data into a discrete component or package that is then encrypted.

As can be seen, there is a need for an encryption algorithm that is based on conditional mathematical formulas instead of non-conditional mathematical formulas.

### SUMMARY OF THE INVENTION

In one aspect of the present invention, a system for encrypting data includes: a computer having a processor, and a non-transitory memory; and a program product comprising machine-readable program code for causing, when executed, the computer to perform encryption of a unit of data according to the following process steps: 1) receiving a plurality of input parameters comprising: a PrimeValue representing the unit of data presented for encryption; a KeyValue representing an encryption key; and a MaximumValue, representing an end point in which Key values and Prime values cannot exceed; 2) performing a primary stage of encryption.

The primary stage of encryption includes determining a first condition of whether the KeyValue is greater than one and is also less than or equal to the MaximumValue; if the first condition is not satisfied, returning the PrimeValue as it is; if the first condition is satisfied, determining a second condition of whether Prime value is equal to the MaximumValue minus the modulus remainder of the MaximumValue divided by the KeyValue; if the second condition is satisfied, assigning the MaximumValue to the PrimeValue and returning the PrimeValue as the encrypted unit of data; if the second condition is not satisfied, determining a third condition of whether the modulus remainder of PrimeValue divided by the KeyValue is equal to 0 (zero); if the third condition is satisfied, incrementing the PrimeValue by the KeyValue minus 1 and returning the incremented PrimeValue as the encrypted unit of data; and if the third condition is not satisfied, decrementing the PrimeValue by 1 and returning the decremented PrimeValue as the encrypted unit of data.

The system may also include a secondary stage of encryption, wherein an encrypted output of the secondary stage of encryption is the PrimeValue input parameter for the primary stage of encryption. The secondary stage of encryption includes: determining an initial condition where the KeyValue is greater than zero and the Key value is less than or equal to a Maximum value; if the initial condition is not satisfied, returning the PrimeValue as it is; if the initial condition is satisfied determining a secondary condition where the PrimeValue is greater than or equal to the KeyValue; if the secondary condition is not satisfied, incrementing the PrimeValue by the MaximumValue minus the KeyValue plus one and returning the incremented PrimeValue as the encrypted output; if the secondary condition is not satisfied, decrementing the PrimeValue by the KeyValue and returning the decremented PrimeValue as the encrypted output.

In other aspects of the invention, the system may also include decryption of the encrypted output. The decryption of the encrypted unit of data by a primary decryption stage proceeds according to the following process steps: receiving the encrypted unit of data as the PrimeValue; determining a first decrypt condition where the KeyValue is greater than one and the KeyValue is less than or equal to the MaximumValue; if the first decrypt condition is not met returning the PrimeValue, as it is, as the unit of data. If the first decrypt condition is met, determining a second decrypt condition where the PrimeValue is equal to the MaximumValue. If the second decrypt condition is met, decrementing the PrimeValue by the modulus remainder of the MaximumValue divided by the KeyValue and returning the decremented PrimeValue as the unit of data. If the second decrypt condition is not met, determining a third decrypt condition where the modulus remainder of the PrimeValue divided by the KeyValue equals the KeyValue minus one. If the third decrypt condition is met, decrementing the PrimeValue by the KeyValue minus one and returning the decremented PrimeValue as the unit of data; and if the third decrypt condition is not met, incrementing the PrimeValue by one and retuning the incremented PrimeValue as the unit of data.

In certain aspects of the invention, the decryption system may also include a secondary stage of decryption to be utilized before the primary stage of decryption, if the secondary stage of encryption was used to encrypt a unit of data. The secondary stage of encryption determines a primary condition where the KeyValue is greater than zero and the Key value is less than or equal to a Maximum value. If the primary decrypt condition is not satisfied, the unit of data is returned, as it is. If the primary decrypt condition is satisfied, then the secondary decrypt condition where the PrimeValue is less than the MaximumValue minus the KeyValue plus one. If the ternary decrypt condition is satisfied, incrementing the PrimeValue by the KeyValue and returning the incremented PrimeValue as the unit of data. If the ternary decrypt condition is not satisfied, decrementing the PrimeValue by the MaximumValue minus the KeyValue plus one and returning the decremented PrimeValue as the unit of data.

Embodiments of the invention are gain less and other embodiments are lossless.

Other aspects of the invention include a method of encrypting a unit of data in a non-transitory computer storage medium. The method includes; assigning a KeyValue; assigning a MaximumValue; and receiving the unit of data to be encrypted as a PrimeValue. A primary encryption engine configured to encrypt the unit of data is provided and by determines a first condition where the KeyValue is greater than one and is also less than or equal to the MaximumValue. If the first condition is not met, the method returns the PrimeValue as a unit of encrypted data. If the first condition is met, the method determines a second condition where the PrimeValue is equal to the MaximumValue minus the modulus remainder of the MaximumValue divided by the KeyValue. If the second condition is met, assigning the MaximumValue to the PrimeValue as the unit of encrypted data. If the second condition is not met, the method determines a third condition where the modulus remainder of the PrimeValue divided by the KeyValue is equal to zero. If the third condition is met, the PrimeValue is incremented by the KeyValue minus one and the incremented PrimeValue is returned as the unit of encrypted data. If the third determination is not met, the PrimeValue is decremented by one and returns the decremented PrimeValue as the unit of encrypted data.

In other aspects of the invention the method includes a secondary stage of encryption. The method of the secondary stage of encryption includes determining a primary condition where the KeyValue is greater than zero and the KeyValue is less than or equal to MaximumValue. If the primary condition is not met, returning the PrimeValue as the unit of encrypted data. Alternatively, if the primary condition is met, the method determines a secondary condition where the PrimeValue is greater than or equal to the KeyValue. If the secondary condition is met, the PrimeValue is decremented by the KeyValue and the decremented PrimeValue is returned. If the secondary condition is not met, the PrimeValue is incremented by the MaximumValue minus the KeyValue plus one and the method returns the incremented PrimeValue.

These and other features, aspects and advantages of the present invention will become better understood with reference to the following drawings, description and claims.

### BRIEF DESCRIPTION OF THE DRAWINGS

FIG. 1 is a flowchart of an embodiment of an encryption algorithm of the present invention.

FIG. 2 is a flowchart of a ShiftBackward function of an encryption stage according to aspects of the invention.

FIG. 3 is a flowchart of a ShuffleBackward function of an encryption stage according to aspects of the invention.

FIG. 4 is a flowchart of an embodiment of a decryption algorithm of the present invention.

FIG. 5 is a flowchart of a ShiftForward function of a decryption stage according to aspects of the invention.

FIG. 6 is a flowchart of a ShuffleForward function of a decryption stage according to aspects of the invention.

FIG. 7 is a flowchart illustrating a method of encrypting units of data.

FIG. 8 is a flowchart illustrating a method of encrypting a data input from a key input.

FIG. 9 is a flowchart illustrating a method of decrypting units of data.

FIG. 10 is a flowchart illustrating a method of decrypting units of data input from a key input.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system, method, and apparatus for the perpetual encryption and decryption of data with a virtually endless number of bytes or elements. As stated above, most encryption algorithms can be easily hacked or penetrated because they lack the capacity to be used for perpetual encryption. As used herein, “perpetual encryption” entails the continuous encryption/decryption of data containing a virtually endless number of bytes or data elements.

The encryption of the present invention utilizes a pseudorandom function family (PRF), called ShiftBackward and ShuffleBackward to encrypt data and ShuffleForward and ShiftForward to decrypt data. When “daisy chained” within conditional loops, the system can be used to encrypt and decrypt bytes or arrays of data with a virtually endless number of bytes or elements for perpetual encryption.

This encryption algorithm is capable of both lossless and gainless encryption algorithm that is virtually unbreakable when used for perpetual encryption. By comparison, other systems usually either increase the size of the data or use lossy compression to shorten the data. That is they package the data into a discrete component or package that is then encrypted.

As will be familiar to those in the art, the strength of an encryption algorithm is typically measured in terms of the number or size of the encryption keys used. For most encryption algorithms are ranked in terms of bits, with 512-bit encryption being advanced encryption. By contrast, the present invention allows for perpetual bits or bytes with 4-bits to 64-bits or 1-byte to 8-bytes being the potential unit size that can be used ad infinitum.

This encryption algorithm utilized by the present invention is based on conditional mathematical formulas instead of non-conditional mathematical formulas. It can be used as a component of an encryption algorithm for computers, cell phones, routers, switches, wireless networking, etc.

### Encryption

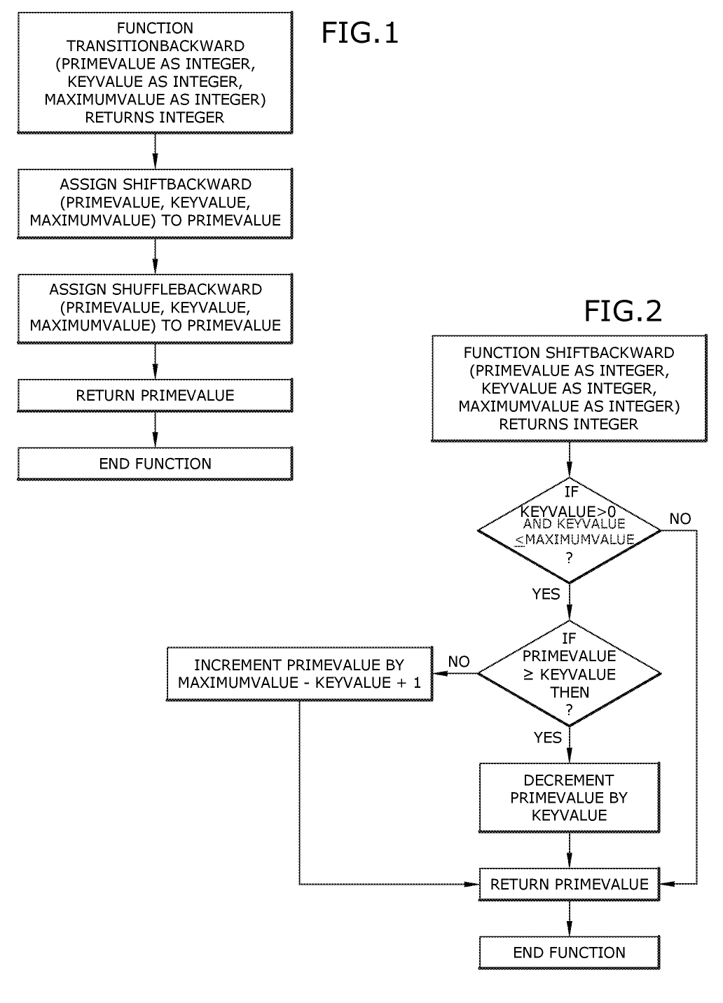

As seen in reference to FIG. 1, a flowchart for implementing a perpetual encryption process according to embodiments of the invention is illustrated.

At step 1, the process starts with the invocation of the TransitionBackward function. The TransitionBackward function is a function called to invoke encryption of a source of unencrypted data. The TransitionBackward function utilizes specified numeric parameters PrimeValue, KeyValue, and MaximumValue, and returns an encrypted version of a unit of data. A unit of data is usually represented as 8-bit elements known as bytes, but it can take on other formats as well.

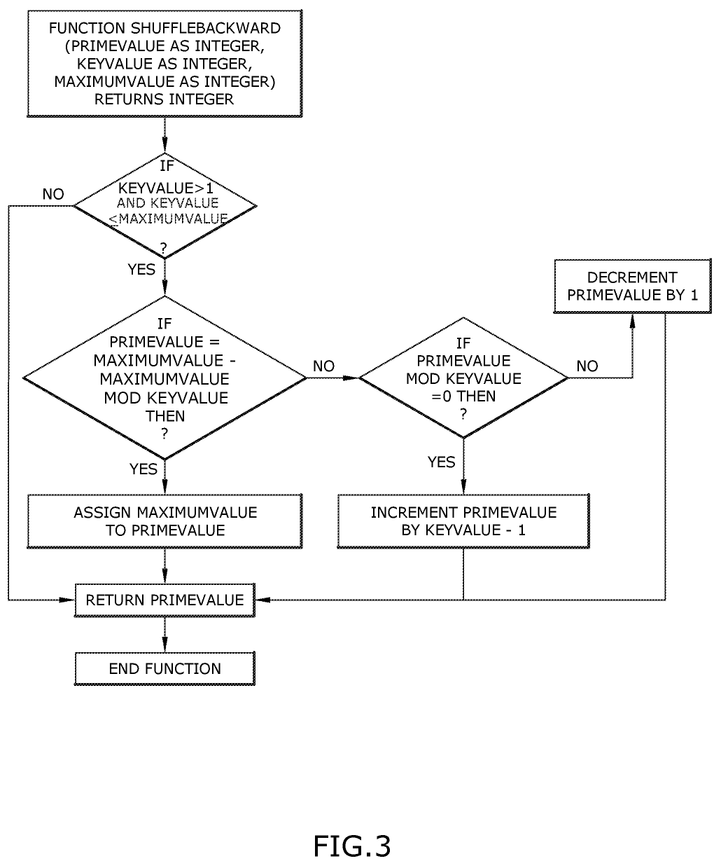

In most high-level programming languages, when functions are invoked, any declared variables or parameters are applicable to the function only and can only return a single value known simply as the return value, which can be assigned to a variable. In the present invention, the return value is the encrypted or decrypted value. Keep in mind that the functions depicted in FIG. 1 and FIG. 3 are mirror functions in that if one of them is invoked to encrypt a value, then the other function must be used to decrypt the output of the other function.

If the output of FIG. 1 or FIG. 3 is used to re-encrypt its output with the same maximum value with a second, third, fourth, etc. key value then its mirror function must be used to decrypt the final encrypted output with the same maximum value with each key value that was used for encryption to begin with but in reverse of the original order in which the key values were submitted for encrypting, also known as First In, Last Out (FILO). All of this can be done using conditional loops.

### Parameters

The PrimeValue parameter is used to specify a unit of data input from a data source, such as a non-transitory memory storage, a hard drive or a digital network transmission. The unit of data input may be a source unencrypted data, or in certain embodiments, may be a source of encrypted data that is input for further encryption. PrimeValue is specified within the range of 0 (zero) and MaximumValue.

The KeyValue parameter is used to specify an encryption key. The KeyValue typically comes from an ASCII (1 byte) or Unicode (2 or more bytes) data unit of a file or password, although other formats are also permissible. KeyValue is within the range of 0 (zero) and MaximumValue, with 0s (zeros) ignored and 1s (ones) ignored by the shuffling algorithims.

The MaximumValue parameter is used to specify an end point for encryption in which key values and prime values cannot exceed. Since most file systems are reducible to ASCII (1 byte) or a variation thereof like Unicode (2 bytes), a MaximumValue of 255 would be the norm used for most file partitions and systems, but a larger number such as 65,535 for Unicode would allow for more encryption variations, but might exclude remainder bytes if used for ASCII files unless a more complex modification of the invention is used to account for that. The MaximumValue is typically specified within the source code of the program being created although it could be specified by the user, a file, or by network transmission.

Based on the function parameters, the TransitionBackward function obtains the necessary data which is represented in numbers and returns an integer, thereby providing the initial inputs for at least one stage of encryption. A primary stage of encryption is provided through the ShuffleBackward function. An optional secondary stage of encryption is provided through the ShiftBackward function. The following description will discuss the TransitionBackward encryption functions with both stages of encryption. When utilizing only the primary, ShuffleBackward stage, the parameters specified as inputs from the TransitionBackward function are utilized by the ShuffleBackward function.

### ShiftBackward

At this optional stage of encryption, the encryption algorithm assigns values to the ShiftBackward function illustrated in reference to FIG. 2. The function operates with the assigned numeric parameters PrimeValue, KeyValue, MaximumValue. Upon execution, the function assigns the returned value to PrimeValue. ShiftBackward performs predetermined binary calculations within the central processing unit (CPU) in order to achieve a first stage of encryption, referred to herein as “shifting”.

According to the algorithm, the ShiftBackward function first determines whether the KeyValue is greater than 0 (zero) and the KeyValue is less than or equal to MaximumValue. If both conditions are not true, the function returns an integer to PrimeValue.

If KeyValue is greater than zero and KeyValue is less than or equal to MaximumValue, the algorithm determines whether PrimeValue is greater than or equal to KeyValue. If the PrimeValue is greater than or equal to KeyValue, the function decrements PrimeValue by the KeyValue and returns the decremented PrimeValue. If the PrimeValue is not greater than or equal to the KeyValue, the function increments PrimeValue by the quantity MaximumValue minus KeyValue plus 1 (one). The function then returns the incremented PrimeValue. Upon returning an incremented or decremented PrimeValue, the ShiftBackward function ends. Representative code for performing the ShiftBackward function is shown in reference to Table 1.

TABLE 1
ShiftBackward

```
START FUNCTION ShiftBackward(PrimeValue, KeyValue,
MaximumValue)
IF KeyValue > 0 AND KeyValue ≤ MaximumValue THEN
  IF PrimeValue ≥ KeyValue THEN
    Decrement PrimeValue by KeyValue
  ELSE
    Assign MaximumValue - KeyValue + PrimeValue + 1 to PrimeValue
  END IF
END IF
  RETURN PrimeValue
END FUNCTION
```

### ShuffleBackward

Referring again to the flowchart of FIG. 1, the ShuffleBackward function, shown in reference to FIG. 5 then is executed. ShuffleBackward performs predetermined binary calculations within the CPU in order to achieve a primary stage of encryption referred to herein as “shuffling”.

The ShuffleBackward function receives the returned PrimeValue from the preceding ShiftBackward function, when present, otherwise it receives a unit of data presented for encryption.

As seen in reference to FIG. 5, the ShuffleBackward function first determines whether KeyValue is greater than 1 (one) and is also less than or equal to MaximumValue. If the KeyValue relations are not satisfied, the function returns PrimeValue and ends.

If KeyValue is greater than 1 (one) and is less than or equal to MaximumValue, the function next determines if Prime value is equal to the MaximumValue minus the modulus remainder of the MaximumValue divided by the KeyValue. If the determination is that it is equal, the MaximumValue is assigned to PrimeValue and the function returns the PrimeValue.

If it is not equal, the ShuffleBackward function determines whether the modulus remainder of the PrimeValue divided by the KeyValue is equal to 0 (zero). If it is equal to zero, the function increments the PrimeValue by the KeyValue minus 1 (one) and returns the incremented PrimeValue and the function ends. If this determination is not equal, the function decrements PrimeValue by 1 (one) and returns the decremented PrimeValue and the function ends.

Representative code for performing the ShuffleBackward function is shown in reference to Table 2.

TABLE 2
ShuffleBackward

```
START FUNCTION ShuffleBackward (PrimeValue, KeyValue,
MaximumValue) and return an integer
IF KeyValue > 1 AND KeyValue ≤ MaximumValue THEN
  IF PrimeValue > MaximumValue - MaximumValue mod KeyValue
THEN
    Assign MaximumValue to PrimeValue
  ELSE IF PrimeValue mod KeyValue = 0 THEN
    Increment PrimeValue by KeyValue - 1
  ELSE
    Decrement PrimeValue by 1
  END IF
END IF
RETURN PrimeValue
END FUNCTION
```

Referring again to the flowchart of FIG. 1, at step 4, the TransitionBackward function, returns the PrimeValue. The returned PrimeValue, becomes the encrypted return value, and thus the TransitionBackward function submits the encrypted version of the original PrimeValue to whatever function called it so that it can be assigned to a variable therein.

### Decryption

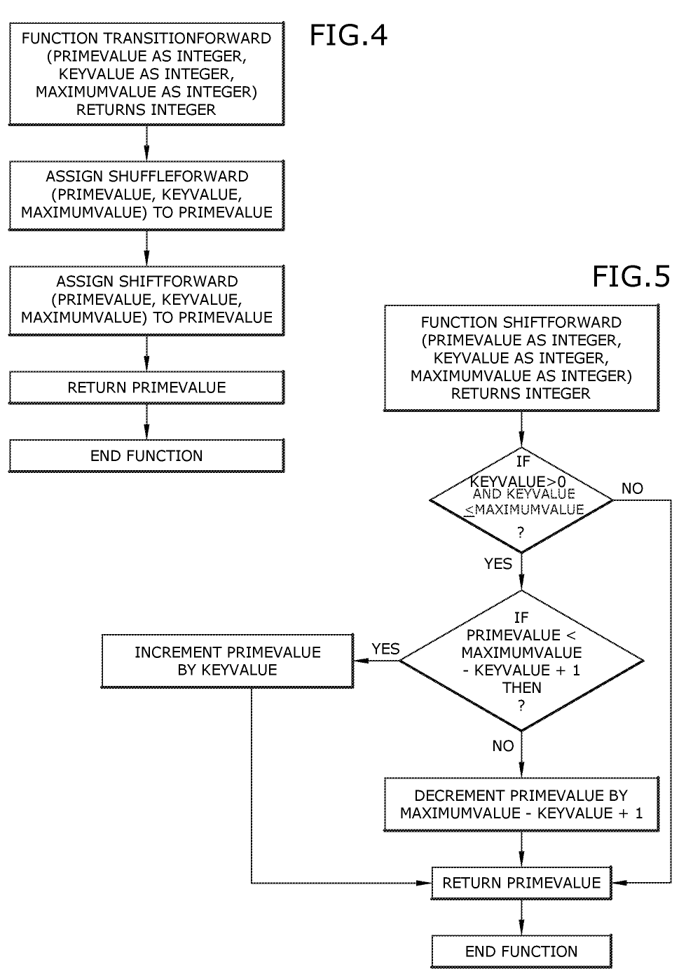

As seen in reference to FIG. 4, a flowchart for implementing a perpetual decryption process according to embodiments of the present invention is illustrated.

The decryption process starts with the invocation of the TransitionForward function. The TransitionForward function is a function called to invoke decryption of a source of data, encrypted with the foregoing TransitionBackward function of the present invention. The TransitionForward function utilizes the same specified numeric parameters PrimeValue, KeyValue, and MaximumValue, and returns a decrypted version of a unit of data. A unit of data is usually represented as 8-bit portions known as bytes, but it can take on other formats. The sequence of the shuffling and shifting operations during encryption of the units of data are reversed from that of the encryption process during the decryption process.

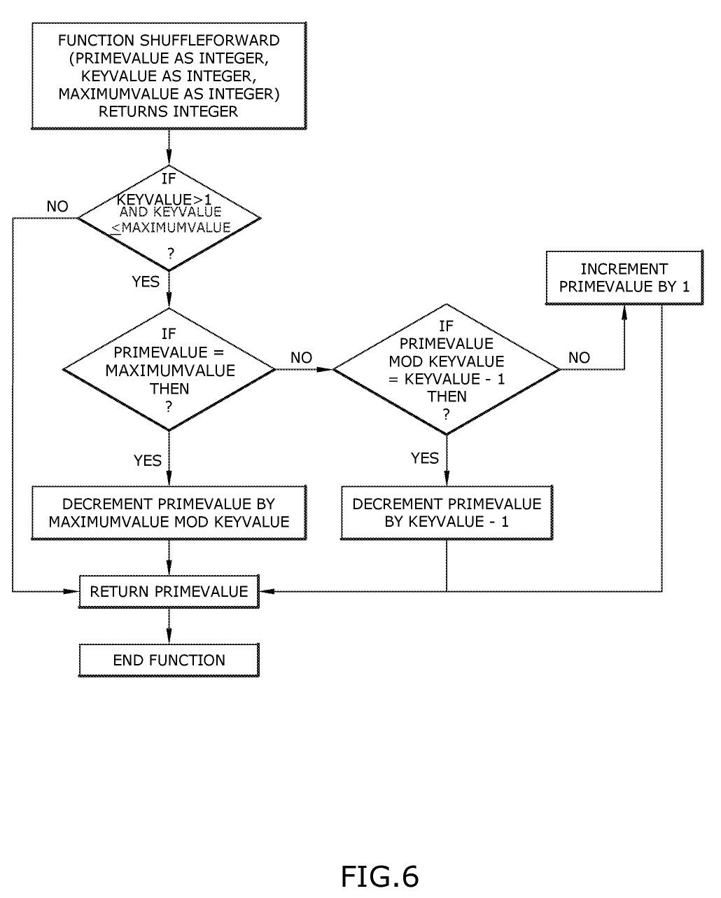

After invoking the TransitionForward function, the parameters are assigned in the first instance to the ShuffleForward function, illustrated in reference to FIG. 6. In this instance, PrimeValue is provided by the first unit of data to be decrypted.

As seen in reference to FIG. 6, the function first determines whether the KeyValue is greater than 1 (one and is less than or equal to the MaximumValue. If both conditions are not satisfied, ShuffleForward returns PrimeValue.

If ShuffleForward determines that the KeyValue is not greater than 1 (one) and is not less than or equal to the MaximumValue, the function determines whether the PrimeValue is equal to the MaximumValue. If this condition is satisfied, the Prime value is decremented by the modulus remainder of the MaximumValue divided by the KeyValue.

If the function determines that the PrimeValue is not equal to the MaximumValue, the process determines whether the modulus remainder of the PrimeValue divided by the KeyValue is equal to the KeyValue minus one. If the determination is yes, the PrimeValue is decremented by the KeyValue minus one (1). If the determination is no, the PrimeValue is incremented by 1. In both instances the decremented or incremented PrimeValue is returned, reflecting a first stage of decryption.

Representative code for performing the ShuffleForward function is shown in reference to Table 3.

TABLE 3
ShuffleForward (FIG. 6)

```
START FUNCTION ShuffleForward(PrimeValue, KeyValue,
MaximumValue)
IF KeyValue > 1 AND KeyValue ≤ MaximumValue THEN
  IF PrimeValue = MaximumValue THEN
    Decrement PrimeValue by MaximumValue mod KeyValue
  ELSE IF PrimeValue mod KeyValue = KeyValue - 1 THEN
    Decrement PrimeValue by KeyValue - 1
  ELSE
    Increment PrimeValue by 1
  END IF
END IF
RETURN PrimeValue
END FUNCTION
```

After receiving the returned PrimeValue from the ShuffleForward function, the TransitionForward function assigns the values to the ShiftForward function. As seen in reference to FIG. 5, the ShiftForward function first determines whether the KeyValue is greater than zero. If it is not, the function returns the PrimeValue and the function ends.

If the KeyValue is greater than zero, the ShiftForward function then determines whether the PrimeValue is less than the MaximumValue minus the KeyValue plus one. If the function determines that it is not, the PrimeValue is decremented by the MaximumValue minus the KeyValue plus one, the decremented value is returned and the function ends.

If the function determines that the PrimeValue is less than the MaximumValue minus the KeyValue plus one, the function increments the PrimeValue by the KeyValue and the function ends.

In this case, the returned PrimeValue from the ShiftForward function represent the decrypted units of data from the second stage of decryption.

Representative code for performing the ShiftForward function is shown in reference to Table 4.

TABLE 4
ShiftForward (FIG. 4)

```
START FUNCTION ShiftForward(PrimeValue, KeyValue, and
MaximumValue)
IF KeyValue > 0 And KeyValue ≤ MaximumValue THEN
  IF PrimeValue < MaximumValue - KeyValue + 1 THEN
  Increment PrimeValue by KeyValue
  ELSE
  Assign MaximumValue - KeyValue + PrimeValue + 1 to PrimeValue
  END IF
END IF
RETURN PrimeValue
END FUNCTION
```

In order to encrypt a byte or element with a compound key consisting of many bytes or elements, read the keys or elements in the form of bytes or elements in the original order using a conditional loop. An array of bytes or elements can be encrypted by reading all of its bytes in any order in the form of a conditional loop and then proceeding to use a one-byte or one-element key or a compound key to encrypt its contents.

In order to decrypt a byte or element with a compound key consisting of many bytes or elements, read the keys in the form of bytes or elements in the reverse order in the form of a conditional loop. An array of bytes or elements can be decrypted by reading all of its bytes or elements in any order in the form of a conditional loop and then proceeding to use a one-byte key or a compound key to decrypt its contents.

The present invention may be made utilizing one of a procedural language, preferably one with functions, or an object-orientated language.

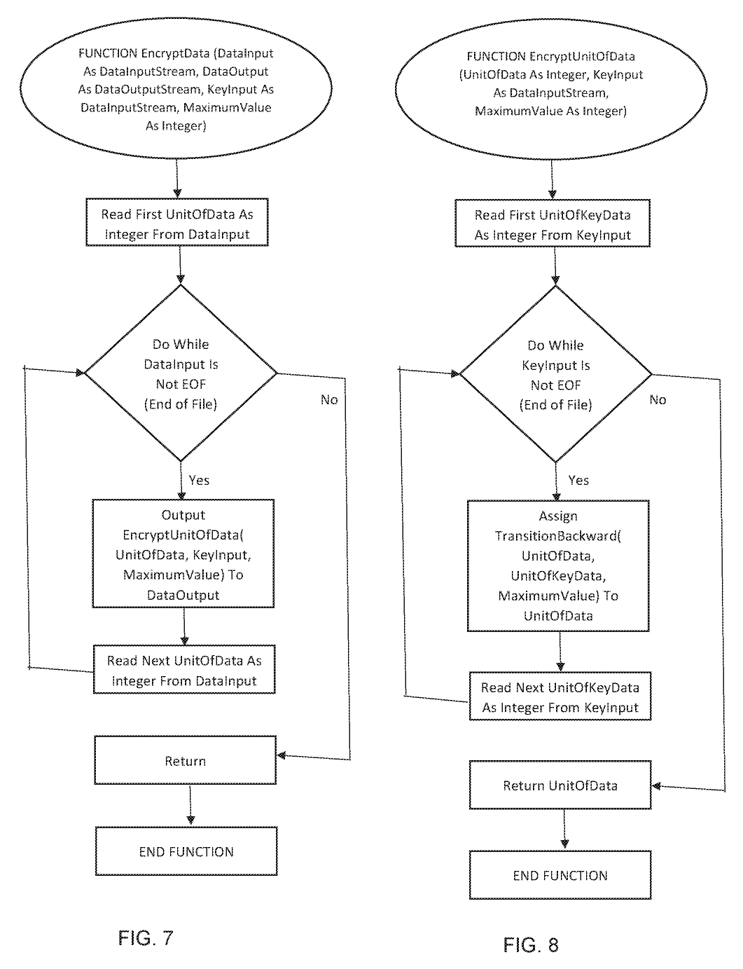

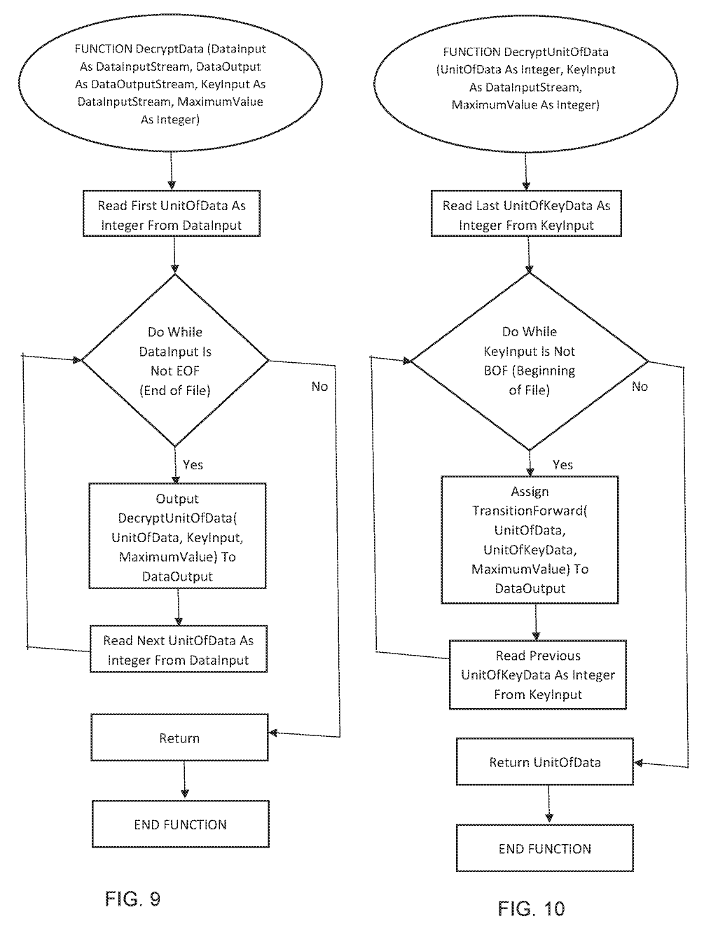

The ShiftForward and ShiftBackward functions are optional components to make the encryption system work better. Using conditional loops with the EncryptData and EncryptUnitOfData routines shown in reference to FIGS. 7 and 8, and the encode functions could be used to make the encryption algorithm perform perpetual encryption. The conditional looping needed to do perpetual encryption and decryption may vary, a necessary component of making the encryption algorithm perform at optimal levels, particularly in the form of perpetual encryption. Mirror conditional loop decoding is illustrated in reference to FIGS. 9 and 10, utilizing DecryptData and DecryptUnitOf Data routines.

The algorithms provided would serve as functions within an existing program that would make an encryption system work, especially in the form of a perpetual encryption algorithm.

The present invention can be used as a component of an encryption algorithm for computers, cell phones, routers, switches, wireless networking, and may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

I claim:

1. A system for encrypting data, comprising:
a computer having a processor, and a non-transitory memory; and
a program product comprising machine-readable program code for causing, when executed, the computer to perform encryption of a unit of data according to the following process steps:
receiving a plurality of input parameters comprising: a PrimeValue representing the unit of data presented for encryption; a KeyValue representing an encryption key; and a MaximumValue, representing an end point for which prime values and key values cannot exceed;
performing a primary stage of encryption, comprising:
determining a first condition of whether the KeyValue is greater than 1 and is also less than or equal to the MaximumValue;
if the first condition is not satisfied returning the PrimeValue as an encrypted unit of data;
if the first condition is satisfied, determining a second condition of whether Prime value is equal to the MaximumValue minus the modulus remainder of the MaximumValue divided by the KeyValue;
if the second condition is satisfied, assigning the MaximumValue to the PrimeValue and returning the PrimeValue as the encrypted unit of data;
if the second condition is not satisfied, determining a third condition of whether the modulus remainder of the PrimeValue divided by the KeyValue is equal to 0 (zero);
if the third condition is satisfied, incrementing the PrimeValue by the KeyValue minus 1 and returning the incremented PrimeValue as the encrypted unit of data; and
if the third condition is not satisfied, decrementing PrimeValue by 1 and returning the decremented PrimeValue as the encrypted unit of data.

2. The system of claim 1, further comprising:
performing a secondary stage of encryption, wherein an encrypted output of the secondary stage of encryption is the PrimeValue input parameter for the primary stage of encryption.

3. The system of claim 2, wherein the secondary stage of encryption comprises:
determining a first condition where the KeyValue is greater than zero and the key value is less than or equal to a maximum value;
if the first condition is not satisfied, returning the PrimeValue as the encrypted output;
if the first condition is satisfied
determining a second condition where the PrimeValue is greater than or equal to the KeyValue;
if the second condition is not satisfied, decrementing the PrimeValue by the KeyValue and returning the decremented PrimeValue as the encrypted output.
if the second condition is satisfied, incrementing the PrimeValue by the MaximumValue minus the KeyValue plus one and returning the incremented PrimeValue as the encrypted output.

4. The system of claim 1, further comprising:
decrypting the encrypted unit of data by a primary decryption stage according to the following process steps:
receiving the encrypted unit of data as the PrimeValue;
determining a first decrypt condition where the KeyValue is greater than one and the KeyValue is less than or equal to the MaximumValue;
if the first decrypt condition is not met returning the PrimeValue as the unit of data;
if the first decrypt condition is met, determining a second decrypt condition where the PrimeValue is equal to the MaximumValue;
if the second decrypt condition is met, decrementing the PrimeValue by the modulus remainder of the MaximumValue divided by the KeyValue and returning the decremented PrimeValue as the unit of data;
if the second decrypt condition is not met, determining a third decrypt condition where the modulus remainder of the PrimeValue divided by the KeyValue equals KeyValue minus one;
if the third decrypt condition is met, decrementing the PrimeValue by the KeyValue minus one and returning the decremented PrimeValue as the unit of data; and
if the third decrypt condition is not met, incrementing the PrimeValue by one and retuning the incremented PrimeValue as the unit of data.

5. The system of claim 4, further comprising:
decrypting the encrypted unit of data by a secondary decryption stage according to the following process steps:
receiving the encrypted unit of data as the PrimeValue;
determining a first decrypt condition where the KeyValue is greater than one and the KeyValue is less than or equal to the MaximumValue;
if the first decrypt condition is not satisfied, return the unit of data as it is;
if the second decrypt condition is satisfied, determining a third decrypt condition where the PrimeValue is less than the MaximumValue minus the KeyValue plus one;
if the third decrypt condition is satisfied, incrementing the PrimeValue by the KeyValue and returning the incremented PrimeValue as the unit of data;
if the third decrypt condition is not satisfied, decrementing the PrimeValue by the MaximumValue minus the KeyValue plus one and returning the decremented PrimeValue as the unit of data.

6. The system of claim 1, wherein the encryption is gain less.

7. The system of claim 1, wherein the encryption is lossless.

8. A method of encrypting a unit of data in a non-transitory computer storage medium, comprising:
assigning a KeyValue
assigning a MaximumValue;
receiving the unit of data to be encrypted as a PrimeValue;
providing a primary encryption engine configured to encrypt the unit of data by determining a first condition where the KeyValue is greater than one and is also less than or equal to the MaximumValue;
if the first condition is not met, returning the PrimeValue as a unit of encrypted data;
if the first condition is met, determining a second condition where the PrimeValue is equal to the MaximumValue minus the modulus remainder of the MaximumValue divided by the KeyValue;
if the second condition is met, assigning the MaximumValue to the PrimeValue as the unit of encrypted data;
if the second condition is not met, determining a third condition where the modulus remainder of the PrimeValue divided by the KeyValue is equal to zero;
if the third condition is met incrementing the PrimeValue by the KeyValue minus one and return the incremented PrimeValue as the unit of encrypted data;
if the third determination is not met, decrementing the PrimeValue by one and return the decremented PrimeValue as the unit of encrypted data.

9. The method of claim 1, further comprising:
a secondary stage of encryption comprising:
determining a first condition where the KeyValue is greater than zero and the KeyValue is less than or equal to MaximumValue;
if the first condition is not met, returning the PrimeValue as it is;
if the first condition is met, determining a secondary condition where the PrimeValue is greater than or equal to the KeyValue;
if the second condition is met, decrementing the PrimeValue by the KeyValue and returning the decremented PrimeValue;
if the second condition is not met incrementing the PrimeValue by the MaximumValue minus the KeyValue plus one and returning the incremented PrimeValue.
